(19) United States
(12) Patent Application Publication
(10) Pub. No.: US 2004/0127618 A1
(43) Pub. Date: Jul. 1, 2004

(54) Tough polymers

(76) Inventors: Herbert Ulmer, Bussum (NL); Timothy Gillece, Pompton Plains, NJ (US); John Katirgis, West Caldwell, NJ (US); Joseph Albanese, Belle Mead, NJ (US); Raymond Rigoletto JR., Denville, NJ (US)

Correspondence Address: INTERNATIONAL SPECIALTY PRODUCTS, Attn: William J. Davis, Esq., 1361 Alps Road, Legal Department, Building No. 10, Wayne, NJ, 07470, US

(21) Appl. No.: 10/720,912

(22) Filed: Nov. 24, 2003

Related U.S. Application Data
(60) Provisional application No. 60/429,488, filed on Nov. 27, 2002.

(51) Int. Cl. C08K 5/05

(52) U.S. Cl. 524/379; 525/244

(57) ABSTRACT

What is described herein is a tough yet flexible polymer which is polyvinyl alcohol grafted with a water or alcohol soluble monomer. The grafted polymer has strong holding properties and high humidity resistance, which are particularly suitable for use in hair styling and skin care products. The grafted polymer preferably is made in a solvent such as water, alcohol and water-alcohol mixtures, in the presence of an initiator.

### CROSS-REFERENCE TO RELATED U.S. PATENT APPLICATION

This application is based upon Provisional Application Serial No. 60/429,488, filed Nov. 27, 2002.

### BACKGROUND OF THE INVENTION

1. Field of the Invention

This invention relates to polymers useful in hair styling products, and, more particularly, to a tough yet flexible polymer of polyvinyl alcohol (PVA) grafted with a water or alcohol soluble monomer, which, in solution with a solvent of water or alcohol, or mixtures thereof, is particularly suitable for use as a hair styling polymer.

2. Description of the Prior Art

Hair styling polymers, and solutions thereof, are well known in the art. However, for one or more reasons, such polymers usually fail to deliver an optimum performance desired by the user. Most particularly, none are tough and yet flexible, or possess solubility in water or alcohol, or mixtures thereof.

Nozawa et al, in U.S. Pat. No. 6,068,937 described a recording sheet having a receptive layer thereon which was a blend of a water absorbent copolymer and a water-resistant, self-crosslinked, graft copolymer whose main chain is polyvinyl alcohol grafted with a vinyl monomer having a carboxylic group and a monomer having a functional group reactive with the carboxylic group. When heated the vinyl monomer having a carboxyl group which is contained in the copolymer of acrylic acid and vinyl alcohol and the monomer having a functional group reacting with the carboxyl group contained in the graft copolymer of polyvinyl alcohol react with each other, i.e., self-crosslinked, producing a desired recording sheet. These polymer blends are not particularly useful for personal care products, such as hair styling products which require aqueous or alcoholic solubility.

Accordingly, it is an object of this invention to provide new and improved hair styling polymers having the physical attributes of toughness, strong holding properties, flexibility, high humidity resistance, and aqueous or alcoholic solubility.

### SUMMARY OF THE INVENTION

What is described herein is a tough yet flexible polymer which is polyvinyl alcohol (PVA) grafted With a water or alcohol soluble monomer, usually in solution with a solvent selected from water, alcohol and water-alcohol mixtures.

The water or alcohol soluble monomer suitably is vinyl pyrrolidone, vinyl caprolactam, dimethylaminopropyl methacrylamide, dimethylaminoethyl methacrylate, acrylic acid, hydroxyethylmethacrylate, vinyl pyridine, ethoxylated acrylates, methacrylic acid, methylmethacrylate, or their quats, (2-methacryloxy) ethyl trimethylammonium sulfate, (2-methacylaryloxy) ethyl (trimethylammonium chloride), 1-vinylimidazole, styrene, vinyl aminosilicones and mixtures thereof, and the like.

Preferably the tough polymer is polyvinyl alcohol grafted with 1-99% mole % of such water or alcohol soluble monomer, preferably 10-50 mole %.

The tough polymer preferably is made by reacting polyvinyl alcohol and a water or alcohol soluble monomer in water, alcohol or water-alcohol mixtures, or water-alkane, with an initiator. Representative initiators include H₂O₂, ceric complexes, ammonium persulfate (APS), sodium persulfate, potassium persulfate, cumene peroxide, t-butyperoxypivalate, benzoyl peroxide, and mixtures of each.

### DETAILED DESCRIPTION OF THE INVENTION

In this invention, there is described a new and improved hair styling polymer which is polyvinyl alcohol (PVA) grafted with a water or alcohol soluble monomer. The grafted polymer exhibits unique physical characteristics of toughness, strong hold, flexibility, high humidity resistance, and water or alcohol solubility, which are particularly suitable for use in hair and skin products. The amount and composition of the grafting will provide the preferred solubility and physical properties of the polymer.

Typical grafting water or alcohol soluble monomers include vinylpyrrolidone (VP), dimethylamino methacrylamide (DMAPMA), 2-[[(butylamino)carbonyl]oxy]ethyl acrylate (BECA), dimethylaminoethyl methacrylate (DMAEMA), methylmethacrylate (MMA), methacrylamide, methacrylic acid (MAA), quats thereof, and mixtures of the above.

The invention will now be described with reference to the following examples.

### EXAMPLE 1

### PVA-GRAFTED WITH VP

The reaction mixture comprised the following:

| | |
|---|---|
| PVA (87-89% hydrolyzed, MW 31-50 K)* | 150 g |
| Water (100 g w/H₂O₂; 100 g w/VP; 250 g up front) | 450 |
| VP | 50 |
| H₂O₂ (35%) (14, 29 g aq.) | 5 |
| | ˜30% solids |

*Celvol ® 205 (Celanese Chemicals).

The product was hazy, with no color; pH 4.80; and formed a tough, flexible film which was clear and colorless.

### EXAMPLE 2

### PVA-GRAFTED WITH VP-2-(METHACRYLOYLOXY)-ETHYL TRIMETHYLAMMONIUM SULFATE (QUAT) COPOLYMER

| | |
|---|---|
| PVA (87-89% hydrolyzed, MW 31-50 K) | 150 g |
| Water | 450 |
| VP | 40 |
| Quat | 5 |
| H₂O₂ | 5 |
| | ˜30% solids |

Product pH 4.80, tough, flexible film 25 μ, formed compatible, clear (12 NTU) Carbopol® 980 gel.

### EXAMPLE 3

### PVA-GRAFTED WITH VP-QUAT COPOLYMER

| | |
|---|---|
| PVA (98-99% hydrolyzed, MW 85-146 K) | 150 g |
| Water (100 g w/mixed monomer; 100 g w/initiator; | 450 |
| 250 g up front) | |
| VP | 25 |
| Quat | 25 |
| H₂O₂ | 5 |
| | 27.5% solids |

Similar tough, flexible films obtained.

### EXAMPLE 4

| | |
|---|---|
| PVOH, (87-89%, hydrolyzed, 31-50 K) | 150 g |
| DMAPMA | 25 g |
| VP | 25 g |
| MMA | 7.5 g |
| Water | 400 g |
| Ethanol | 50 g |
| H₂O₂ | 5 g |
| | ˜31% solids |

Process:

1. 150 g of PVOH was added to the reactor (1-L) along with 300 g of water. The system was purged 3 times with N₂ (g). Agitation was set to 175 rpm.

2. The mixture was heated to 80° C., evacuated and held for 2 hours to solubilize the PVOH.

3. 11.11% of the 14.29 g of H₂O₂, 35% was added to the system.

4. (a) After 15 minutes monomer feeds started. 25 g VP+7.5 g MMA, 25 g DMAPMA+50 g water+50 g ethanol were added with syringe pump over 90 minutes.

4. (b) At the same time 4 (a) feed starts, the remaining H₂O₂, 35%+50 g water was added over 120 minutes.

5. The reaction mixture was held at 80° C. for another 120 minutes prior to cooling to ambient and discharging.

The product was viscous, colorless and clear. The 25 μ neat films were stiff, flexible and continuous.

### EXAMPLE 5

| | |
|---|---|
| PVOH, (87-89%, hydrolyzed, 31-50 K) | 90 g |
| AA, glacial | 60 g |
| Heptane | 300 g |
| Water | 150 g |
| Ethanol | 50 g |
| H₂O₂ | 6 g |
| | ˜23% solids |

Process:

1. 90 g of PVOH was added to the reactor (1-L) along with 150 g of water. The system was purged 3 times with N₂ (g). Agitation was set to 200 rpm.

2. The mixture was heated to 80° C., evacuated and held for 2 hours to solubilize the PVOH.

3. 25% of the 17.14 g of H₂O₂, 35% was added to the system.

4. The remaining H₂O₂, 35%+25 g water was added over 60 minutes.

5. 50 g of ethanol was added to the system.

6. The reaction mixture was held at 80° C. for another 120 minutes prior to cooling to ambient and discharging.

The product was viscous, slightly hazy and colorless.

### EXAMPLE 6

| | |
|---|---|
| PVOH, (87-89%, hydrolyzed, 31-50 K) | 100 g |
| BECA | 50 g |
| Methanol | 210 g |
| Water | 250 g |
| APS | 5 g |
| | ˜25% solids |

*Product white, opaque, viscous solution.

TABLE 1
PVOH-Grafted Polymers - Polymer (% by Wt.)

| | | | | | | | | % Solids |
|---|---|---|---|---|---|---|---|---|
| Ex. | | | | | | | % | (PVOH |
| No. | VP | DMAPMA | MAA | MMA | Mol. Wt. | PVOH | Hydrolysis | Soln) |
| 5 | 12 | 12 | — | 3.6 | 31-50K | 73.4 | 87-89 | 30.3 |
| 6 | 12 | 12 | 3.6 | — | 31-50K | 73.4 | 87-89 | 30.2 |
| 7 | 12 | 12 | 3.6 | — | 85-146K | 73.4 | 87-89 | 19.5 |
| 8 | 12 | 12 | 3.6 | — | 85-146K | 73.4 | 98-99 | 20.5 |
| 9 | 12 | 12 | — | 3.6 | 85-146K | 73.4 | 87-89 | 20.1 |
| 10 | 12 | 12 | 3.6 | — | 31-50K | 73.4 | 98-99 | 21 |
| 11 | 12 | 12 | 3.6 | — | 85-146K | 73.4 | 96 | 20 |
| 12 | 12 | — | 3.6 | — | 31-50K | 84.4 | 87-89 | 30.3 |
| 13 | 12 | 12 | — | — | 31-50K | 76.0 | 87-89 | 30.8 |

| | 2% Actives | 5% Actives |
|---|---|---|
| Formulation 1 | A | B |
| Ingredient | Wt % | Wt % |
| D.I. Water | 57.28 | 47.39 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA/MMA} | 6.61 | 16.50 |
| (12:12:3.6) (30.30% active) | | |
| TEA 99 | 0.81 | 0.81 |
| Total | 100.00 | 100.00 |
| | 2% Actives | 5% Actives |
| Formulation 2 | C | D |
| Ingredient | Wt % | Wt % |
| D.I. Water | 53.63 | 38.25 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA/MAA} | 10.26 | 25.64 |
| (12:12:3.6) (19.50% active) | | |
| TEA 99 | 0.81 | 0.81 |
| Total | 100.00 | 100.00 |
| | 2% Actives | 5% Actives |
| Formulation 3 | E | F |
| Ingredient | Wt % | Wt % |
| D.I. Water | 54.13 | 39.49 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA/MAA} | 9.76 | 24.40 |
| (12:12:3.6) (20.50% active) | | |
| TEA 99 | 0.81 | 0.81 |
| Total | 100.00 | 100.00 |
| | 2% Actives | 5% Actives |
| Formulation 4 | G | H |
| Ingredient | Wt % | Wt % |
| D.I. Water | 53.94 | 39.01 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA/MMA} | 9.95 | 24.88 |
| (12:12:3.6) (20.10% active) | | |
| TEA 99 | 0.81 | 0.81 |
| Total | 100.00 | 100.00 |
| | 2% Actives | 5% Actives |
| Formulation 5 | A | B |
| Ingredient | Wt % | Wt % |
| D.I. Water | 54.37 | 40.08 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA/MAA} | 9.52 | 23.81 |
| (12:12:3.6) (21.00% active) | | |
| TEA 99 | 0.81 | 0.81 |
| Total | 100.00 | 100.00 |
| | 2% Actives | 5% Actives |
| Formulation 6 | C | D |
| Ingredient | Wt % | Wt % |
| D.I. Water | 53.89 | 38.89 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA/MAA} | 10.00 | 25.00 |
| (12:12:3.6) (20.00% active) | | |
| TEA 99 | 0.81 | 0.81 |
| Total | 100.00 | 100.00 |
| | 2% Actives | 5% Actives |
| Formulation 7 | E | F |
| Ingredient | Wt % | Wt % |
| D.I. Water | 57.28 | 47.39 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/MAA} (12:3.6) | 6.61 | 16.50 |
| (30.70% active) | | |
| TEA 99 | 0.81 | 0.81 |
| Total | 100.00 | 100.00 |
| | 2% Actives | 5% Actives |
| Formulation 8 | G | H |
| Ingredient | Wt % | Wt % |
| D.I. Water | 57.39 | 47.65 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA} | 6.50 | 16.24 |
| (12:12) (30.80% active) | | |
| TEA 99 | 0.81 | 0.81 |
| Total | 100.00 | 100.00 |
| Polymer Actives | 1% Actives | 5% Actives |
| Formulation 9 | A | B |
| Ingredient | Wt % | Wt % |
| D.I. Water | 60.58 | 47.08 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA/MAA} | 3.31 | 16.56 |
| (12:12:3.6) (30.20% active) | | |
| TEA 99 | 0.81 | 0.81 |
| Si-Tec DMC 6031 | 0.00 | 0.25 |
| Total | 100.00 | 100.00 |
| Polymer Actives | 1% Actives | 5% Actives |
| Formulation 10 | C | D |
| Ingredient | Wt % | Wt % |
| D.I. Water | 58.76 | 38.00 |
| Germall Plus ® | 0.20 | 0.20 |
| Dissolvine Na 2S (Na₂ EDTA) | 0.10 | 0.10 |
| Carbomer ® 940 (2% aq. stock) | 25.00 | 25.00 |
| D.I. Water | 10.00 | 10.00 |
| PVOH-CO-{VP/DMAPMA/MAA} | 5.13 | 25.64 |
| (12:12:3.6) (19.50% active) | | |
| TEA 99 | 0.81 | 0.81 |
| Si-Tec DMC 6031 | 0.00 | 0.25 |
| Total | 100.00 | 100.00 |

| | 2% Actives | 5% Actives | 2% Actives | 5% Actives |
|---|---|---|---|---|
| Formulation 11 | A | B | C | D |
| Ingredient | Wt % | Wt % | Wt % | Wt % |
| D.I. Water | 57.48 | 47.87 | 57.27 | 47.33 |
| Germall Plus ® | 0.20 | 0.20 | 0.20 | 0.20 |
| Dissolvine Na 2S (Na₂ EDTA) | 0.10 | 0.10 | 0.10 | 0.10 |
| Carbomer ® 940 (2% aq. stock) | 25.00 | 25.00 | 25.00 | 25.00 |
| D.I. Water | 10.00 | 10.00 | 10.00 | 10.00 |
| PVOH-CO-{VP/DMAPMA/MMA} | 6.41 | 16.02 | 0.00 | 0.00 |
| (31.20% active) | | | | |
| PVOH-CO-{VP/DMAPMA/MAA} | 0.00 | 0.00 | 6.62 | 16.56 |
| (30.20% active) | | | | |
| TEA 99 | 0.81 | 0.81 | 0.81 | 0.81 |
| Total | 100.00 | 100.00 | 100.00 | 100.00 |
| Styling Polymer solids | 2 | 5 | 2 | 5 |

Procedure

1. Add water to main tank start mixing.

2. Add Dissolvine Na 2S (Na₂ EDTA) mix well until dissolved.

3. Add Germall Plus® mix well.

4. Add Carbomer® 940 (2% aq. Stock) mix well.

5. In a separate beaker, premix the other amount of water to the styling polymer and add TEA 99. Mix well.

6. Add the premix to the main tank, mix well until clear.

The addition of 12.5% Quat improves the HHCr while increasing levels of VP decrease HHCR. The Quat also significantly increases stiffness durability, curl snap and manageability. An increased % DMAPMA has a positive effect on on-hair attributes associated with “flexibility”, whereas, increasing % VP and PVOH % hydrolysis has a negative effect on these attributes.

TABLE 2

| | | | | | | 2% Gel |
|---|---|---|---|---|---|---|
| Test | PVOH | VP | DMAPMA | Quat | MMA | (0.3%) |
| # | (% Wt) | (% Wt) | (% Wt) | (% Wt) | (% Wt) | (940) |
| 1 | 75 | 25 | — | — | — | 37 |
| 2 | 75 | 20 | 5 | — | — | 31 |
| 3 | 57 | 26 | 17 | — | — | 46 |
| 4 | 75 | 20 | — | 5 | — | 33 |
| 5 | 67 | 33 | — | — | — | 17 |
| 6 | 75 | 12.5 | — | 12.5 | — | 60 |
| 7 | 71.4 | 12.5 | 12.5 | — | 3.6 | 85 |
| 8 | 74 | 19.8 | — | 6.2 | — | 63 |
| 9 | 75 | 25 | — | — | — | 79 |
| 10 | 71.4 | 12.5 | 12.5 | — | 3.6 | 92 |

While the invention has been described with particular reference to grafting of the water or alcohol soluble monomer onto polyvinyl alcohol, it will be understood that blends of the latter with the polymer of each monomer also may be used as the hair care polymer composition, and that such blends will perform advantageously in hair care products.

### HAIR CARE FORMULATIONS WITH PVOH: PVP POLYMER BLENDS OF INVENTION

TABLE 3

| Model Formulation 1-6 | 2% Actives |
|---|---|
| Ingredient | Wt. % |
| D.I. Water | 95.8 |
| Germall Plus ® | 0.20 |
| Polymer Blend | 4.0 |
| Total | 100.00 |

TABLE 4

| Formulation* | 1 | 2 | 3 | 4 | 5 | 6 |
|---|---|---|---|---|---|---|
| Clarity | 5 | 5 | 5 | 5 | 5 | 5 |
| (5 = Clear/4 = Sl. Hazy/ | | | | | | |
| 3 = Hazy/2 = V. Hazy/ | | | | | | |
| 1 = Opaque | | | | | | |
| Flexibility (Flexible or | F | F | F | F | F | F |
| Brittle) with Knife | | | | | | |
| Pencil Hardness (Pencil | 9 H | 9 H | 9 H | >9 H | >9 H | 9 H |
| Number at Indentation) | | | | | | |
| Tack (Dry) Y/N | N | N | N | N | N | N |
| Water Clarity (Clear, | C | C | C | C | C | C |
| Hazy, CLoudy) | | | | | | |
| Film Smoothness (Smooth | S | S | S | S | S | S |
| or Rough) | | | | | | |
| Film Gloss (Shiny or Dull) | S | S | S | S | S | S |

*1. PVA88:PVP K30(75:25)
2. PVA88:PVP K30(50:50)
3. PVA88:PVP K30(25:75)
4. PVA98:PVP K30(75:25)
5. PVA 98:K30 (50:50)
6. PVA98PVP K30(25:75)

The polymers can be formulated into typical hair care products designed for use in the modes of styling, mousse, gel and spray hair care products. These products performed well in practice giving the user the advantages of the natural feel polymers therein, particularly a firm and flexible characteristic, water-resistance and water-solubility, and excellent high humidity curl retention.

More particularly, the compositions described herein are useful in products for personal care, including, but not limited to, gels, lotions, glazes, glues, mousses, sprays, fixatives, shampoos, conditioners, 2n1 shampoos, temporary hair dyes, semi-permanent hair dyes, permanent hair dyes, straighteners, permanent waves, relaxers, creams, putties, waxes and pomades. The compositions can be used alone or in combination with anionic, nonionic and cationic hair styling polymers, thickeners, film formers, surfactants, reducing agents, oxidizers and other ingredients typically found in personal care products. Specific examples follow:

Gels: Hair and/or skin care compositions wherein the compositions comprise an aqueous or hydroalcoholic gel. Gels can be in the form of spray gels, fluid gels, tube gels and thick viscous tub gels. The compositions can be used preferably at use levels of 0.1-10% by weight in anionic, nonionic or cationic gallants (clear, translucent or opaque), or combinations thereof, such gallants preferably being present in amounts of 0.1-5% by weight.

Anionic gellants include, but are not limited to, carbomer, Acrylates/C10-30 Alkyl Acrylate Crosspolymer, Acrylates Copolymer, Acrylates/Beheneth-25 Methacrylate Copolymer, Acylates/Steareth-20 Methacrylate Copolymer, PVM/MA Decadiene Crosspolymer, Xanthan Gum, sodium polyacrylate, polyacrylamide, copolymers of sodium acrylates, and copolymers of polyacryalmide.

Nonionic gellants include, but are not limited to, guar and their derivatives and celluloses and their derivatives. Examples are hydroxyethyl cellulose, hydroxypropyl cellulose, hydroxymethyl cellulose, hydroxypropyl guar.

Cationic thickeners include, but are not limited to, Polyqaternium 32 (and) mineral oil, and Polyquaternium 37 (and) mineral oil (and) PPG-1 Trideceth-6.

Hair and skin care gel formulations with the compositions using crosslinked homopolymers of acrylic acid, e.g., carbomer and/or Acrylates/C10-30 Alkyl Acrylate Crosspolymer as the gellant result in synergistic performance in moisture resistance. In particular, hair styling gels with the above listed combinations show synergistic high humidity resistance on hair.

Complexation of the compositions with carbomer and/or Acrylates/C10-30 Alkyl Acrylate Crosspolymer results in clear films upon draw down. The resultant viscosity, yield value and suspension capabilities are unaffected or increased by the addition of such compositions into the gellant.

Mousses: The compositions can be incorporated into aerosol and non-aerosol hair and skin mousse formulations, as well as spray mousses which utilize an aerosol valve with a dip tube and a mechanical break-up actuator to deliver an atomized spray foam. They are also compatible in aerosol and non-aerosol shave foam applications. Preferred use levels of the compositions are 0.1-10.0% by weight.

Shampoos and Body Washes: The compositions described are compatible with anionic, amphoteric, cationic and nonionic surfactants. The compositions can be incorporated into cleansing formulations for hair and body. The compositions described can be used preferably at use levels of 0.1 to 10% by weight with anionic, amphoteric, cationic, and nonionic surfactants, or combinations thereof, such surfactants preferably being present in amounts of 0.1 to 20% by weight.

Oil-in-Water Emulsions and Hair Conditioners (including both leave-in and rinse-out): The compositions can be incorporated in hair and skin oil-in-water emulsions. In hair conditioners, the compositions described are compatible with quaternary ammonium compounds. The use level of surfactants/emulsifiers preferably is from 0.1 to 10% by weight.

Oxidative Hair Dyes: The compositions may be incorporated in oxidative hair dye formulations including semi-permanent and permanent hair dye products, preferably at use levels of 0.1-10% by weight.

Relaxers and Permanent Waves: The compositions can be used in relaxer and permanent wave formulations preferably in amounts of 0.1% -10% by weight. They may be combined with hair reducing agents, including, but not limited to, ammonium thioglycolate, guanidine hydroxide, sodium bisulfite and the like. The compositions can also be incorporated in the flow lotion (treatment phase before oxidation/hardening of the hair) or in the neutralizer/oxidizer phase.

Hair Sprays: The compositions can be incorporated in hair sprays, both non-aerosol and aerosol, preferably at use levels of 0.1-10% by weight. Aerosol hair sprays can include up to 60% hydrocarbon, 70% dimethyl ether, 50% Hydrofluorocarbon 152a, or combinations thereof. Hair spray formulations include, but are not limited to, alcohol-free pump hair spray, 55%-95% VOC pump and aerosol hair sprays.

Personal Care Applications: The compositions can be blended with anionic, nonionic and cationic hair styling polymers, thickeners, and film formers; and with anionic, nonionic and cationic surfactants. Clarity in water is increased with low levels of charged surfactants (0.1-2% by weight).

Performance on Hair: The compositions can be formulated into bodifying leave-on or rinse-off hair preparations. They also can be formulated into flexible hold styling products which render smooth continuous films on hair that have strength and will bend under both high and low stress.

Skin Care Applications: The compositions can be used as a film former (a) for the enhancement of antiperspirants to either increase overall wetness protection or reduction in amount of conventional AP active while holding equivalent efficacy, (b) to increase the substantivity of a deodorant active for better and longer acting deodorancy, (c) in an anti-bacterial liquid hand soap to increase efficacy and for longer lasting claim, (d) for holding products on skin, and (e) to increase contact time of a therapeutic skin products containing actives, including, but not limited to, Betulin, vitamin E, A, C, ceramides, Allantoin, lycopenes, bisabolol, retinol, etc.

The compositions can be used in make-up products, (foundation, mascara, bronzers, eyeliners) for film formation, improved wear resistance and pigment dispersion. They can also be used in mascaras for curl retention.

While the invention has been described with particular reference to certain embodiments thereof, it will be understood that changes and modifications may be made which are within the skill of the art. Accordingly, it is intended to be bound only by the following claims, in which:

What is claimed is:

1. A tough polymer which is polyvinyl alcohol grafted in an amount of 1-99 wt % with a water or alcohol soluble or dispersible monomer.

2. A tough polymer according to claim 1 wherein said water soluble monomer is selected from vinyl pyrrolidone, vinyl caprolactam, 2-[[(butylamino)carbonyl]oxy]ethyl acrylate, dimethylaminopropyl methacrylamide, dimethylaminoethyl methacrylate, or their quats, acrylic acid, tetrahydrofurfurylmethacrylate, hydroxyethylmethacrylate, vinyl pyridine, ethoxylated acrylates, methacrylic acid, methylmethacrylate, (2-methacryloxy)ethyl trimethylammonium sulfate, (2-methacylaryloxy) ethyl (trimethylammonium chloride), 1-vinylimidazole, styrene, silicone (eth-, meth-)acrylates, fluoro(eth-, meth-)acrylates, and mixtures thereof, and the like.

3. A tough polymer according to claim 1 in which the polyvinyl alcohol is processed with 1-50 wt. % with said water or ethanol soluble or dispersible monomer.

4. A solution according to claim 1 in which said polymer is dissolved in a solvent selected from water, alcohol, water-alcohol, water-hydrocarbon, or water-alcohol-hydrocarbon mixtures.

5. A process for making the solution of claim 4 which comprises grafting polyvinyl alcohol with a water or alcohol soluble or dispersible monomer in a solvent which is water, alcohol, hydrocarbon, water-alcohol, water-hydrocarbon, or water-alcohol-hydrocarbon mixtures in the presence of an initiator.

6. A process according to claim 5 wherein said free radical or redox initiator is H₂O₂, ceric complexes, ammonium persulfate, sodium persulfate, potassium persulfate, cumene peroxide, t-butyperoxypivalate, or benzoyl peroxide, ferric chloride, hydrogen peroxide-iron, hydrogen peroxide-copper, azo, and mixtures thereof, or the like.

7. A personal care product including the tough polymer of claims 1-3.

8. A hair care product according to claim 7 which forms a tough, yet flexible film on the hair of the user, which is soluble or dispersible in water, alcohol, water-alcohol, water-hydrocarbon, or water-alcohol-hydrocarbon mixtures.

9. A cosmetic or dermatological, film-forming composition according to claim 7 for producing a water-resistant film demonstrating excellent hold and durability properties.

10. A hair care, skin care, or dermatological mixture containing an intimate blend of polyvinyl alcohol and a water or alcohol soluble or dispersible polymer.
